(19) United States
(12) Patent Application Publication
(10) Pub. No.: US 2015/0115501 A1
(43) Pub. Date: Apr. 30, 2015

(54) PROCESS FOR PRODUCING PLASTIC MOULDED PIECES

(71) Applicant: KRAUSSMAFFEI TECHNOLOGIES GMBH, München (DE)

(72) Inventors: Stephan Widmayer, Munchen (DE); Christian Götze, Wohlenschwil (CH)

(73) Assignee: KRAUSSMAFFEI TECHNOLOGIES GMBH, München (DE)

(21) Appl. No.: 14/353,232

(22) PCT Filed: Oct. 26, 2012
(86) PCT No.: PCT/EP2012/071203

§ 371 Date: Apr. 21, 2014

(30) Foreign Application Priority Data
Oct. 29, 2011 (DE) 10 2011 117 338.6

(51) Int. Cl. B29C 51/14

(52) U.S. Cl. CPC B29C 51/145; B29K 2101/12
USPC 264/257

(57) ABSTRACT

A process for producing plastic moulded pieces which include, in particular, at least one formed continuous fibre-reinforced thermoplastic sheet (9) overmoulded with a thermoplastic material, includes the steps of: —providing a continuous fibre-reinforced thermoplastic sheet (9); —providing an oven (10) for heating a continuous fibre-reinforced thermoplastic sheet (9) placed in the oven (10); introducing an anti-adhesive layer (12) in the oven (10); introducing the continuous fibre-reinforced thermoplastic sheet (9) into the oven (10); heating the continuous fibre-reinforced thermoplastic sheet (9) in contact with the anti-adhesive layer (12) to a forming temperature; —removing the heated continuous fibre-reinforced thermoplastic sheet (9) from the oven (10) and transferring same to a mould (15, 7, 8) for forming and/or overmoulding the continuous fibre-reinforced thermoplastic sheet (9).

The invention relates to a process for producing plastic moulded pieces which include, in particular, at least one formed continuous fibre-reinforced thermoplastic sheet overmoulded with a thermoplastic material.

DE 20 2006 019 341 U1 describes a continuous fibre-reinforced thermoplastic sheet structural component with a structure-reinforcing plastic insert, which is back-moulded or respectively at least partially overmoulded with a thermoplastic material such that the plastic insert and the thermoplastic material form a materially connected connection with one another. The continuous fibre-reinforced thermoplastic sheet structural component is produced by back-moulding or respectively overmoulding of a plastic sheet, containing reinforcing material, with a thermoplastic material such that a material connection is achieved between the plastic sheet and the thermoplastic material by setting a suitable temperature and/or a suitable pressure.

It is an object of the invention to provide an improved process for producing plastic moulded pieces which include, in particular, at least one formed continuous fibre-reinforced thermoplastic sheet overmoulded with a thermoplastic material.

The problem is solved by a process for producing plastic moulded pieces which include in particular at least one formed continuous fibre-reinforced thermoplastic sheet overmoulded with a thermoplastic material, comprising the steps of providing a continuous fibre-reinforced thermoplastic sheet, providing an oven for heating a continuous fibre-reinforced thermoplastic sheet placed in the oven, introducing an anti-adhesive layer in the oven, introducing the provided continuous fibre-reinforced thermoplastic sheet into the oven, heating the continuous fibre-reinforced thermoplastic sheet in contact with the anti-adhesive layer to a forming temperature, and removing the heated continuous fibre-reinforced thermoplastic sheet from the oven and transferring the heated continuous fibre-reinforced thermoplastic sheet to a mould for forming and/or overmoulding the continuous fibre-reinforced thermoplastic sheet.

Continuous fibre-reinforced thermoplastic sheets are not actual sheets which contain metallic material plates. Rather, composite plates which contain fibre-reinforced, in particular endless-fibre-reinforced structures which are embedded into a thermoplastic polymer, are designated as continuous fibre-reinforced thermoplastic sheets. Continuous fibre-reinforced thermoplastic sheets can be, in particular, plate-shaped semi-finished products, which have a fibre-reinforced, in particular endless-fibre-reinforced fabric impregnated with a polymer matrix. The fabrics can provide here defined orientations, of their fibres, which are embedded in the polymer matrix or respectively in the thermoplastic polymer. The fibres of the fabric can be, for example, glass fibres, carbon fibres, Kevlar fibres, aramid fibres and/or natural fibres. The fabrics can consist of homogeneous fibres or of combinations of different types of fibres. Generally all thermoplastic materials are suitable as polymer matrix, such as for example polyimide (PA) or glass fibre-reinforced polyimide (PA-GF). Structures or respectively fabrics can be designated as endless-fibre-reinforced, the fibres of which run free of interruption from one end of the continuous fibre-reinforced thermoplastic sheet up to the other end of the continuous fibre-reinforced thermoplastic sheet.

Continuous fibre-reinforced thermoplastic sheets are usually provided as prefabricated semi-finished products in the form of composite plates in the manner of flat sheets in different pre-cut sizes. The flat continuous fibre-reinforced thermoplastic sheets are formed within a process according to the invention for producing plastic moulded pieces. A forming takes place here in a heated state of the continuous fibre-reinforced thermoplastic sheet, in which the polymer matrix or respectively the thermoplastic polymer becomes softer owing to the increase in temperature. In order to be able to soften such continuous fibre-reinforced thermoplastic sheets for forming, the cold, i.e. hard continuous fibre-reinforced thermoplastic sheets are heated in an oven to a specific forming temperature of the respective continuous fibre-reinforced thermoplastic sheet. The oven can be preheated. The actual forming temperature is dependent here inter alia on the material components and the structure of the continuous fibre-reinforced thermoplastic sheet.

Within a process according to the invention, the heated continuous fibre-reinforced thermoplastic sheets are removed from the oven and are transferred for example for forming and overmoulding into a plastic injection moulding machine. On removal of the heated continuous fibre-reinforced thermoplastic sheet for example from a support grid or a mounting bracket in the oven, the continuous fibre-reinforced thermoplastic sheet, owing to its soft state due to the heating in the oven, would remain—without an anti-adhesive layer according to the invention—adhered to the support grid or the mounting bracket at the direct contact points of continuous fibre-reinforced thermoplastic sheet and support grid or mounting bracket, or respectively on removal, the continuous fibre-reinforced thermoplastic sheet would draw threads, i.e. softened material of the surface of the continuous fibre-reinforced thermoplastic sheet would remain adhered to the support grid or to the mounting bracket and become separated from the continuous fibre-reinforced thermoplastic sheet. In addition to a contamination of the oven and/or of a handling device or respectively of the plastic injection moulding machine, it can be disadvantageous if the surface of the continuous fibre-reinforced thermoplastic sheet were altered or respectively destroyed.

According to the invention therefore there is provided an introduction of an anti-adhesive layer into the oven, an introduction of the provided continuous fibre-reinforced thermoplastic sheet into the oven, and a heating of the continuous fibre-reinforced thermoplastic sheet, resting on the anti-adhesive layer according to the invention, to a forming temperature. The anti-adhesive layer can be a stackable sheet or a continuous web, in particular unwound from a roll. The anti-adhesive layer can have a carrier layer of paper, metal or plastic. Alternatively or additionally, the anti-adhesive layer can have a textile carrier layer. The anti-adhesive layer can also be formed from a hybrid material. For example, the anti-adhesive layer can be formed from a plastic with integrated glass fibre fabric. The anti-adhesive layer can be a fabric. The carrier layer can itself have anti-adhesive characteristics. Alternatively, the carrier layer can be impregnated or coated with an anti-adhesive material. The anti-adhesive layer can be constructed for single use or for multiple use. According to the invention, the anti-adhesive layer can be removed again from the continuous fibre-reinforced thermoplastic sheet, the support grid or the mounting bracket or respectively the handling device, or from the plastic injection moulding machine. The anti-adhesive layer is formed in particular by a solid, thin support which is not a coating applied in a fluid manner onto the support grid. The anti-adhesive layer can, however, form a subsequent surface layer of the plastic moulded piece which is to be produced.

An introduction of the anti-adhesive layer into the oven can take place before an introduction of the provided continuous fibre-reinforced thermoplastic sheet into the oven. In particular in the event of the continuous fibre-reinforced thermoplastic sheet being already provided with an anti-adhesive layer, an introduction of the anti-adhesive layer into the oven can take place at the same time as an introduction of the provided continuous fibre-reinforced thermoplastic sheet into the oven. If applicable, an introduction of the anti-adhesive layer into the oven can also take place after an introduction of the provided continuous fibre-reinforced thermoplastic sheet into the oven.

The anti-adhesive layer can have any anti-adhesive materials known per se to the specialist in the art. For example, a PTFE film, a polyimide film and/or a carrier fabric, in particular a coarsely meshed carrier fabric, can be used as anti-adhesive material. Here, the carrier fabric can be equipped with PTFE.

In an embodiment, the anti-adhesive layer can be introduced into the oven as a separate anti-adhesive layer before the introduction of the provided continuous fibre-reinforced thermoplastic sheet, and the continuous fibre-reinforced thermoplastic sheet can be subsequently placed onto the anti-adhesive layer. For this, for example, a sheet of an anti-adhesive layer which is held in readiness can be placed onto a support grid of the oven. The anti-adhesive layer can be placed manually or fed in an automated manner. An automated feeding can take place for example by an unwinding of a section of a carrier web from a spool, wherein the carrier web has the anti-adhesive layer. After the anti-adhesive layer is placed on the support grid of the oven, the continuous fibre-reinforced thermoplastic sheet which is to be heated is placed onto the anti-adhesive layer and subsequently the continuous fibre-reinforced thermoplastic sheet is heated in the oven.

A removal of the heated continuous fibre-reinforced thermoplastic sheet can take place either with or without the anti-adhesive layer.

In an alternative embodiment, the continuous fibre-reinforced thermoplastic sheet can be provided with an anti-adhesive layer applied onto its surface, and the continuous fibre-reinforced thermoplastic sheet can be introduced into the oven jointly together with the applied anti-adhesive layer. In this embodiment, the anti-adhesive layer is therefore already fixed or respectively fastened on a surface of the continuous fibre-reinforced thermoplastic sheet. A continuous fibre-reinforced thermoplastic sheet can be provided with an anti-adhesive layer on its two surfaces. When the continuous fibre-reinforced thermoplastic sheet is already provided with an anti-adhesive layer before an introduction into the oven, a separate placement of an anti-adhesive layer into the oven can be dispensed with. The continuous fibre-reinforced thermoplastic sheet is therefore introduced into the oven together with the anti-adhesive layer, i.e. simultaneously with the anti-adhesive layer.

In all embodiments, the heated continuous fibre-reinforced thermoplastic sheet can be removed from the oven, leaving the anti-adhesive layer in the oven. After the continuous fibre-reinforced thermoplastic sheet has been heated in the oven, the continuous fibre-reinforced thermoplastic sheet can be removed from the anti-adhesive layer during a removal of the continuous fibre-reinforced thermoplastic sheet from the oven simultaneously or immediately before. For this, for example a sheet of an anti-adhesive layer placed manually into the oven can be fastened to a support grid of the oven such that on a removal of the continuous fibre-reinforced thermoplastic sheet from the support grid, the anti-adhesive layer detaches itself from the continuous fibre-reinforced thermoplastic sheet, and the anti-adhesive layer remains securely connected with the support grid. The anti-adhesive layer which has remained can then be used again for example for a further continuous fibre-reinforced thermoplastic sheet which is to be heated in the oven. Alternatively or additionally, the used anti-adhesive layer can be removed separately, in particular manually, from the oven again, for example by the used anti-adhesive layer being removed manually from the support grid.

Alternatively, the heated continuous fibre-reinforced thermoplastic sheet can be removed from the oven together with the anti-adhesive layer. If the anti-adhesive layer is removed from the oven together with the continuous fibre-reinforced thermoplastic sheet, then a separate, in particular subsequent or manual removal of the anti-adhesive layer from the oven can be dispensed with. If the anti-adhesive layer is removed from the oven together with the continuous fibre-reinforced thermoplastic sheet, then in addition the anti-adhesive layer can be used to prevent an adhering together of the continuous fibre-reinforced thermoplastic sheet with a handling apparatus or its end effector, i.e. gripper, during or after the continuous fibre-reinforced thermoplastic sheet is transferred by means of the handling apparatus into a mould of an injection moulding machine.

The anti-adhesive layer can be removed from the continuous fibre-reinforced thermoplastic sheet in particular before, during or after a transfer of the continuous fibre-reinforced thermoplastic sheet into the mould and before a forming of the continuous fibre-reinforced thermoplastic sheet. The anti-adhesive layer can therefore be removed together with the continuous fibre-reinforced thermoplastic sheet, wherein the anti-adhesive layer is removed again outside the oven. This is expedient for example when the continuous fibre-reinforced thermoplastic sheet is to be formed and/or overmoulded without the presence of an anti-adhesive layer. In other words, in these cases the anti-adhesive layer is not to remain in the mould.

Alternatively, the anti-adhesive layer can remain in the mould during a forming of the continuous fibre-reinforced thermoplastic sheet and can be removed from the continuous fibre-reinforced thermoplastic sheet after the forming of the continuous fibre-reinforced thermoplastic sheet and before an overmoulding of the continuous fibre-reinforced thermoplastic sheet. The anti-adhesive layer can fulfil its function in the mould. Thus, the anti-adhesive layer can, for example, prevent the continuous fibre-reinforced thermoplastic sheet from remaining adhered to a surface of the mould in an undesired manner. Thus, during a forming process in the mould a shifting of the surfaces of continuous fibre-reinforced thermoplastic sheet to the surface of the mould can be desired or even necessary. The anti-adhesive layer according to the invention can permit or even promote this desired shift. If the anti-adhesive layer is not also be overmoulded during the overmoulding, then the anti-adhesive layer can be removed before the overmoulding of the formed continuous fibre-reinforced thermoplastic sheet.

In another embodiment, the anti-adhesive layer can remain in the mould during a forming and overmoulding of the continuous fibre-reinforced thermoplastic sheet, and can be removed from the continuous fibre-reinforced thermoplastic sheet after the forming and overmoulding. Thus, for example, during the overmoulding process the anti-adhesive layer can also remain on a surface of the continuous fibre-reinforced thermoplastic sheet which is not used for the overmoulding, i.e. which is not injected with plastic material.

In a further embodiment, the anti-adhesive layer can remain in the mould during a forming and overmoulding of the continuous fibre-reinforced thermoplastic sheet, and on a removal of the continuous fibre-reinforced thermoplastic sheet from the mould can be removed together with the continuous fibre-reinforced thermoplastic sheet, and in particular can remain as an additional surface layer on the continuous fibre-reinforced thermoplastic sheet.

In a further embodiment, the anti-adhesive layer can be introduced, connected with a carrier web, into the oven and the heated continuous fibre-reinforced thermoplastic sheet, after a detaching of the anti-adhesive layer from the carrier web, can be removed from the oven together with the anti-adhesive layer. The anti-adhesive layer can be fixed here firstly on a carrier web, or the anti-adhesive layer is formed by a section of the carrier web. In order to remove the anti-adhesive layer from the oven together with the continuous fibre-reinforced thermoplastic sheet, the anti-adhesive layer can be detached from the carrier web in that the continuous fibre-reinforced thermoplastic sheet is drawn out from the oven, wherein the anti-adhesive layer remains connected with the continuous fibre-reinforced thermoplastic sheet and detaches itself from the carrier web or respectively tears itself from the latter.

In such an embodiment, the anti-adhesive layer can be formed from a section of the carrier web, in particular from a section which is separable from the carrier web in a contour-defined manner by means of a perforation. By means of a perforation, a preferred tear-off edge is provided, along which the anti-adhesive layer separates itself from the carrier web, when the continuous fibre-reinforced thermoplastic sheet is removed from the oven.

In all embodiments, the anti-adhesive layer, and/or a carrier web which has the anti-adhesive layer, can be formed from an individual sheet, which is placed into the oven. The anti-adhesive layer can thereby be introduced into the oven as a separate individual sheet for example before the introduction of the provided continuous fibre-reinforced thermoplastic sheet, and the continuous fibre-reinforced thermoplastic sheet can be subsequently placed onto the individual sheet. For this, for example, an individual sheet of the anti-adhesive layer which is held in readiness can be placed onto a support grid of the oven. The anti-adhesive layer can be placed manually or fed in an automated manner. After the individual sheet is placed on the support grid of the oven, the continuous fibre-reinforced thermoplastic sheet which is to be heated is placed onto the individual sheet and subsequently the continuous fibre-reinforced thermoplastic sheet is heated in the oven.

In all embodiments, alternatively the anti-adhesive layer and/or a carrier web which has an anti-adhesive layer, can be formed from a section of an endless web which in particular is unwound from a spool and is conveyed into a placement position arranged in the oven. The anti-adhesive layer can therefore be fed continuously, in particular as a web unwound from a roll or a spool, into the oven, in particular onto the support grid of the oven. The roll or respectively the spool, which has the carrier web with the anti-adhesive layer, can be held in readiness completely within the oven, or can be conveyed from outside the oven in sections into the oven. An automated feeding can therefore take place by an unwinding of a section of a carrier web from a spool, wherein the carrier web has the anti-adhesive layer.

Generally the anti-adhesive layer can be applied on one side or on both sides of the continuous fibre-reinforced thermoplastic sheet.

Moreover, in all embodiments furthermore an application of a further anti-adhesive layer can additionally take place on at least one surface section of the mould or of a gripper handling the continuous fibre-reinforced thermoplastic sheet, in particular a gripper of an automated handing apparatus.

An example embodiment of the invention is illustrated by way of example in the enclosed diagrammatic figures. It is shown in:

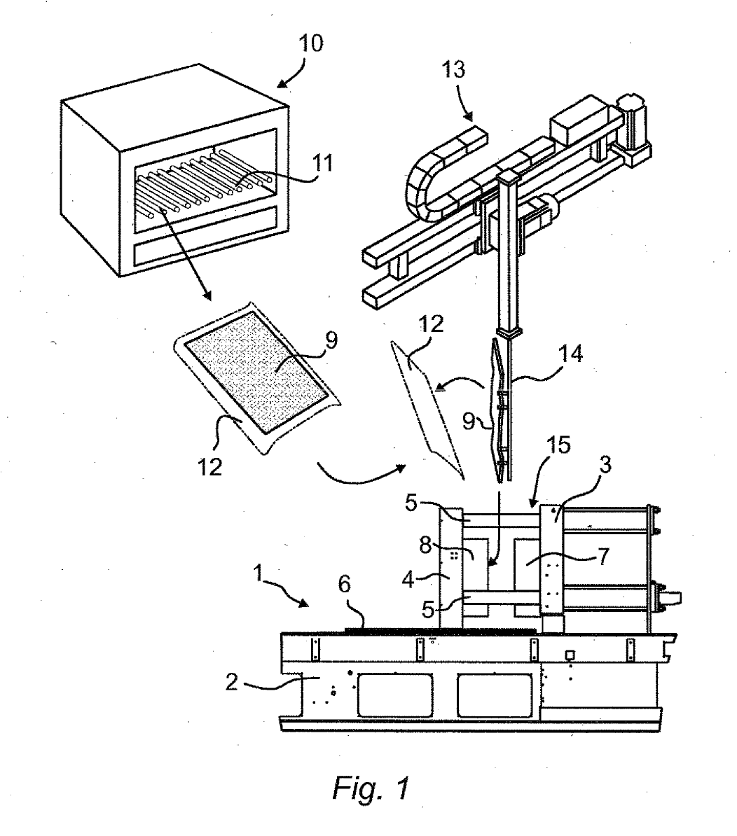

FIG. 1 diagrammatic illustrations of an oven, of an anti-adhesive layer according to the invention with a placed continuous fibre-reinforced thermoplastic sheet, a handling apparatus and an injection moulding machine as components for carrying out a process according to the invention;

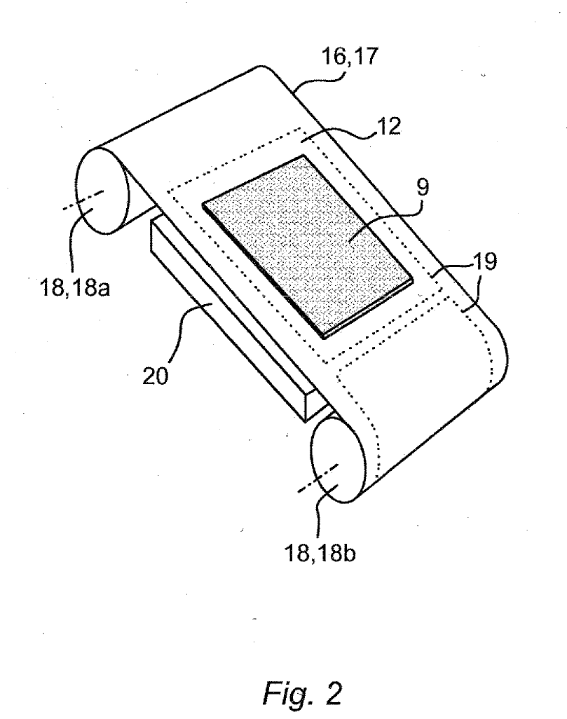

FIG. 2 a perspective illustration of a device with a spool, of which a section of an endless web forms the anti-adhesive layer and/or a carrier web which has the anti-adhesive layer.

In FIG. 1 an example injection moulding machine 1 is illustrated. The injection moulding machine 1 has a machine bed 2. On the machine bed 2 a fixed platen 3 is fastened and a movable platen 4 is mounted so as to be displaceable linearly. For its linearly displaceable mounting, the movable platen 4 is mounted displaceably along four horizontal columns 5. The movable platen 4 can be moved for example by hydraulic drives, not illustrated in further detail, along the longitudinal extent of the four horizontal columns 5. The movable platen 4 is mounted on the machine bed 2 so as to be movable horizontally by linear guides 6. A first injection mould half 7 is fastened to the fixed platen 3. A second injection mould half 8 is fastened to the movable platen 4. In the present example embodiment, the two injection mould halves 7 and 8 are constructed to be able to form a continuous fibre-reinforced thermoplastic sheet 9 and to overmould it with thermoplastic material. The continuous fibre-reinforced thermoplastic sheet 9 can be, for example, a plate-shaped continuous fibre-reinforced thermoplastic sheet 9.

According to an example embodiment of a process according to the invention for producing plastic moulded pieces, as illustrated diagrammatically in FIG. 1, in a first step an oven 10 is provided. The oven 10 is arranged to heat a continuous fibre-reinforced thermoplastic sheet 9 which is placed into the oven 10. The oven 10 can be preheated. In the example embodiment which is shown, the oven 10 has in addition a support grid 11. Furthermore, not only is the continuous fibre-reinforced thermoplastic sheet 9 provided, but also an anti-adhesive layer 12 according to the invention is provided in that the anti-adhesive layer 12 is firstly introduced into the oven 10, by the anti-adhesive layer 12 being placed onto the support grid 11. Subsequently, in the present example embodiment, the provided continuous fibre-reinforced thermoplastic sheet 9 is placed onto the anti-adhesive layer 12 and is heated in the oven 10. After the continuous fibre-reinforced thermoplastic sheet 9 has reached its forming temperature, in a next step the continuous fibre-reinforced thermoplastic sheet 9, in the example embodiment shown, is removed from the oven 10 together with the anti-adhesive layer 12 by means of a handling apparatus 13. For this, the handling apparatus 13 can have, for example, a needle gripper 14 which is constructed to hold the continuous fibre-reinforced thermoplastic sheet 9. With the handling apparatus 13, the continuous fibre-reinforced thermoplastic sheet 9 can be, in addition, transferred into a mould 15 of the injection moulding machine 1 for the forming and overmoulding of the continuous fibre-reinforced thermoplastic sheet 9. In the example embodiment shown, the mould 15 is formed by the two injection mould halves 7 and 8.

In this example embodiment, the anti-adhesive layer 12 is introduced as a separate anti-adhesive layer 12 into the oven 10 before the introduction of the provided continuous fibre-reinforced thermoplastic sheet 9, and the continuous fibre-reinforced thermoplastic sheet 9 is subsequently placed onto the anti-adhesive layer 12. Here, the anti-adhesive layer 12 is formed by an individual sheet which is placed into the oven 10. In the example embodiment shown, the anti-adhesive layer 12 is only applied on one side of the continuous fibre-reinforced thermoplastic sheet 9.

The heated continuous fibre-reinforced thermoplastic sheet 9 is removed from the oven 10 together with the anti-adhesive layer 12. The anti-adhesive layer 12 is then removed from the continuous fibre-reinforced thermoplastic sheet 9, as shown diagrammatically, during the transferring of the continuous fibre-reinforced thermoplastic sheet 9 to the mould, still before a forming of the continuous fibre-reinforced thermoplastic sheet 9.

In FIG. 2 there is illustrated in an example embodiment how a carrier web 16, which has the anti-adhesive layer 12, is formed from a section of an endless web 17, which can be unwound from a spool 18 and conveyed into a placement position arranged in the oven 10. The anti-adhesive layer 12 can thus be introduced, connected with the carrier web 16, into the oven 10, and the heated continuous fibre-reinforced thermoplastic sheet 9, after a detaching of the anti-adhesive layer 12 from the carrier web 16, can be removed from the oven 10 together with the anti-adhesive layer 12. In such an embodiment, the anti-adhesive layer 12 is able to be separated from the carrier web 16 in a contour-defined manner for example by means of a perforation 19.

The device can have a first spool 18a, on which a number of anti-adhesive layers 12 are held available lined up consecutively on the carrier web 16. The carrier web 16 is wound on the spool 18a. From this spool 18a a section of the endless web 17 runs over a support 20 away to a second spool 18b, onto which the used carrier web 16 is wound again. The support 20 can, for example, also be formed by the support grid 11 of the oven 10. The entire device, or else only parts of the device, can be arranged inside the oven 10.

### LIST OF REFERENCE NUMBERS

1 injection moulding machine
2 machine bed
3 fixed platen
4 movable platen
5 horizontal columns
6 linear guides
7 first injection mould half
8 second injection mould half
9 continuous fibre-reinforced thermoplastic sheet
10 oven
11 support grid
12 anti-adhesive layer
13 handling apparatus
14 needle gripper
15 mould
16 carrier web
17 endless web
18, 18a, 18b spool
19 perforation
20 support

What is claimed:

1.-15. (canceled)

16. A process for producing a plastic moulded piece, comprising:
introducing a continuous fibre-reinforced thermoplastic sheet and an anti-adhesive layer into an oven;
heating the continuous fibre-reinforced thermoplastic sheet in contact with the anti-adhesive layer in the oven to a forming temperature;
removing the heated continuous fibre-reinforced thermoplastic sheet from the oven and transferring the heated continuous fibre-reinforced thermoplastic sheet to a mould; and
forming and overmoulding the continuous fibre-reinforced thermoplastic sheet in the mould with a thermoplastic material.

17. The process of claim 16, wherein the anti-adhesive layer is introduced into the oven as a separate anti-adhesive layer before introduction of the provided continuous fibre-reinforced thermoplastic sheet, and the continuous fibre-reinforced thermoplastic sheet is subsequently placed onto the anti-adhesive layer.

18. The process of claim 16, wherein the anti-adhesive layer is applied onto a surface of the continuous fibre-reinforced thermoplastic sheet, and the continuous fibre-reinforced thermoplastic sheet is introduced into the oven jointly together with the applied anti-adhesive layer.

19. The process of claim 16, wherein the heated continuous fibre-reinforced thermoplastic sheet is removed from the oven, leaving the anti-adhesive layer in the oven.

20. The process of claim 16, wherein the heated continuous fibre-reinforced thermoplastic sheet is removed from the oven together with the anti-adhesive layer.

21. The process of claim 16, wherein the anti-adhesive layer is removed from the continuous fibre-reinforced thermoplastic sheet before, during or after a transfer of the continuous fibre-reinforced thermoplastic sheet into the mould and before the continuous fibre-reinforced thermoplastic sheet is formed.

22. The process of claim 16, wherein the anti-adhesive layer remains in the mould while the continuous fibre-reinforced thermoplastic sheet is formed and is removed from the continuous fibre-reinforced thermoplastic sheet after forming of the continuous fibre-reinforced thermoplastic sheet and before the continuous fibre-reinforced thermoplastic sheet is overmoulded.

23. The process of claim 16, wherein the anti-adhesive layer remains in the mould during forming and overmoulding of the continuous fibre-reinforced thermoplastic sheet and is removed from the continuous fibre-reinforced thermoplastic sheet after the continuous fibre-reinforced thermoplastic sheet is overmoulded is formed and overmoulded.

24. The process of claim 16, wherein the anti-adhesive layer remains in the mould during forming and overmoulding of the continuous fibre-reinforced thermoplastic sheet, and on a removal of the continuous fibre-reinforced thermoplastic sheet from the mould is removed together with the continuous fibre-reinforced thermoplastic sheet.

25. The process of claim 24, wherein the anti-adhesive layer remains as an additional surface layer on the continuous fibre-reinforced thermoplastic sheet.

26. The process of claim 16, further comprising connecting the anti-adhesive layer with a carrier web, with the anti-adhesive layer together with the carrier web being introduced into the oven, and detaching of the anti-adhesive layer from the carrier web before the heated continuous fibre-reinforced thermoplastic sheet is removed from the oven together with the anti-adhesive layer.

27. The process of claim 26, wherein the anti-adhesive layer is formed by a section of the carrier web.

28. The process of claim 27, wherein the section is separable from the carrier web in a contour-defined manner by a perforation.

29. The process of claim 16, wherein the anti-adhesive layer or a carrier web which has the anti-adhesive layer is formed by an individual sheet which is placed into the oven.

30. The process of claim 16, wherein the anti-adhesive layer or a carrier web which has the anti-adhesive layer is formed by a section of an endless web which is unwound and conveyed into a placement position arranged in the oven.

31. The process of claim 30, wherein the endless web is wound from a spool.

32. The process of claim 16, wherein the anti-adhesive layer is applied on one side or on both sides of the continuous fibre-reinforced thermoplastic sheet.

33. The process of claim 16, further comprising applying a further anti-adhesive layer onto at least one surface section of the mould or of a gripper handling the continuous fibre-reinforced thermoplastic sheet.

34. The process of claim 33, wherein the gripper is part of an automated handling apparatus.
